(19) United States
(12) Patent Application Publication
(10) Pub. No.: US 2022/0025160 A1
(43) Pub. Date: Jan. 27, 2022

(54) HALOGEN-FREE, FLAME-RETARDANT HYDROGENATED NITRILE BUTADIENE RUBBER

(71) Applicant: Zeon Chemicals, LP, Louisville, KY (US)

(72) Inventors: Doris Darya Fleischmann, Düsseldorf (DE); Björn Nelson, Kaarst (DE); Paul Thomas Ruscoe, Wales (GB); Corina Neumeister, Neumarkt (DE); Pia Lindorf, Lintach-Gemeinde Freudenberg (DE)

(21) Appl. No.: 16/934,742

(22) Filed: Jul. 21, 2020

(51) Int. Cl. C08L 9/02; C08K 5/098; C08K 3/22

(52) U.S. Cl. CPC C08L 9/02; C08K 5/098; C08K 3/22; C08K 2003/2296; C08L 2201/02; C08K 2003/2227; C08K 2201/005; C08L 2205/025

(57) ABSTRACT

A rubber blend comprises hydrogenated nitrile rubber, zinc acrylate, and alumina trihydrate. In some embodiments, the rubber blend is a mixture of a nanocomposite of hydrogenated nitrile rubber and the zinc acrylate, alumina trihydrate, and hydrogenated nitrile rubber. It has improved flame retardancy while maintaining processing and mechanical properties.

### BACKGROUND

Due to the increasing concerns regarding fire safety and the continuously expanding use of polymers in various fields, the market demand for flame retardant polymers in transportation, wire and cable, construction and electrical/electronic products has been steadily increasing. As polymers are mainly composed of carbon, hydrogen and oxygen, they tend to burn at relatively low limited oxygen index (LOI) values. A broad range of flame retardants (FR) exists on the market to improve the flame retardancy of polymers.

The metal hydroxide alumina trihydrate (ATH) is the most commonly used inorganic halogen-free flame retardant (HFFR). However, HFFR require high levels of loading, which not only leads to difficulties in processing but also results in inferior mechanical properties.

### BRIEF SUMMARY

A rubber blend comprises hydrogenated nitrile rubber, zinc acrylate, and alumina trihydrate. In some embodiments, the rubber blend is a mixture of a nanocomposite of hydrogenated nitrile rubber and zinc acrylate; alumina trihydrate; and hydrogenated nitrile rubber. It has improved flame retardancy while maintaining processing and mechanical properties.

These and other objects and advantages shall be made apparent from the accompanying drawings and the description thereof.

### DETAILED DESCRIPTION

Hydrogenated nitrile rubber (HNBR, trade name Zetpol®) is produced by Zeon from nitrile rubber (NBR) by selective hydrogenation of the butadiene units, hereby enhancing the resistance to heat, ozone and chemicals. HNBR is used in the automotive, energy and offshore industries for a large variety of applications, e.g. sealings, gaskets, hoses, roll covers, belts and pump stators, whenever service temperatures between −40° C. and 150° C. along with excellent resistance to oil and automotive fluids are required.

Zeoforte® ZSC is based on a modification of Zetpol® polymer grades and comprises highly dispersed zinc methacrylate (ZMA) and zinc di-methacrylate (ZDMA) moieties. The in-situ grafting of ZMA and ZDMA onto the HNBR polymer chain during vulcanization and the subsequent generation of ionic crosslinks leads to unique polymer properties and improves tensile strength, abrasion resistance and dynamic properties. The use of Zeoforte® ZSC brings significant benefits in processing, as low compound viscosities at high hardness values can be obtained. In general, Zeoforte® ZSC is used in a blend with Zetpol® to provide balanced compound properties.

The difficulties of using HFFR, which require high levels of loading, leading to difficulties in processing and inferior mechanical properties can be overcome with the described rubber blend. An optimum balance between processability, mechanical properties and flame-retardant properties can be achieved, along with excellent high-temperature and oil resistance.

The rubber blend comprises hydrogenated nitrile rubber, zinc acrylate, and alumina trihydrate. In some embodiments, the rubber blend is a mixture of a nanocomposite of hydrogenated nitrile rubber and the zinc acrylate, alumina trihydrate, and hydrogenated nitrile rubber.

Examples of zinc acrylate include, but are not limited to zinc methacrylate, zinc di-methacrylate.

In some embodiments, the rubber blend comprises a plasticizer. Examples of a plasticizer include, but are not limited to conventional plasticizer such as tris(2-ethylhexyl)trimellitate) and flame-retardant plasticizer such as an 2-ethylhexyl diphenyl phosphate.

In some embodiments, the rubber blend comprises 60 phr to 100 phr hydrogenated nitrile butadiene rubber (HNBR), such as 80 phr to 90 phr HNBR; 0 phr to 40 phr Zeoforte® ZSC, such as 10 phr to 20 phr Zeoforte® ZSC; and 100 phr to 200 phr alumina trihydrate (ATH), such as 140 phr to 180 phr ATH. In some embodiments, the alumina trihydrate has a D90 particle size ranging from 0.6 μm to 3.2 μm, such as 2.4 μm. In some embodiments, a plasticizer is added in amounts of 0 phr to 15 phr, such as 5 phr, and can be a conventional plasticizer such as tris(2-ethylhexyl)trimellitate), or a flame-retardant plasticizer, such as a 2-ethylhexyl diphenyl phosphate.

In some embodiments, the curing system is a peroxide. The curing system comprises between 6 phr and 12 phr peroxide, such as bis(tert-butylperoxyisopropyl) benzene, dicumyl peroxide, dialkyl peroxide or diacyl peroxide, and 0 phr to 10 phr peroxide coagent, such as trifunctional (meth)acrylate ester, triallyl cyanurate, zinc diacrylate, zinc dimethacrylate, or a combination of the same.

In some embodiments, the rubber blend further comprises zinc oxide, such as 0 phr to 5 phr zinc oxide (which may be a high purity zinc metal coated with propionic acid), such as 3 phr; as well as up to 2 phr of a processing aid (i.e., internal lubricant and dispersing aid, such as a blend of unsaturated primary amide of fatty acid and fatty acid derivatives), and up to 4 phr antioxidants, such as amine-based antioxidants, benzimidazoles, or a combination of the like.

An exemplary formulation comprises 80 phr Zetpol® 2010L, 20 phr Zeoforte® ZSC2195LCX, 140 phr Apyral® 60CD, 5 phr Phosflex 362, 3 phr zinc oxide XFT-H, 2 phr Ultralube IMX, 1.5 phr Vanox CDPA, 1 phr Vanox ZMTI, 1 phr TAIC, 4 phr SR-517 and 8 phr Luperox F40P-SP2.

By using a blend of HNBR and Zeoforte® ZSC that comprises ATH and a phosphor-based, flame-retardant plasticizer, an optimum balance between processability, mechanical properties and flame-retardant properties can be achieved, along with excellent high-temperature and oil resistance.

In some embodiments, Zeoforte® ZSC, which is a nanocomposite comprising Zetpol® HNBR and zinc di(meth)acrylate, can be replaced by Zetpol® HNBR and zinc di(meth)acrylate in the respective contents.

By tailoring the compound composition, an optimum balance between processability, mechanical properties and flame-retardant properties can be achieved. Due to their broad application temperature range (from −40° C. to 150° C.) and their excellent resistance to oil and automotive fluids, the resulting HFFR-HNBR compounds are well suitable for the use in harsh environments, e.g. sealings, gaskets, hoses, roll covers, belts, wire and cable coverings, and pump stators.

While the present disclosure has illustrated by description several embodiments and while the illustrative embodiments have been described in considerable detail, it is not the intention of the applicant to restrict or in any way limit the scope of the appended claims to such detail. Additional advantages and modifications may readily appear to those skilled in the art. Furthermore, features from separate lists can be combined; and features from the examples can be generalized to the whole disclosure.

### EXAMPLES

### Examples Part 1

The rubber compounds are produced by means of an internal mixer to produce the masterbatch and a two-roll mill to incorporate the curatives. Curing conditions: 170° C./20 min press-cure, 150° C./4 h post-cure.

LOI test: Performed in accordance with DIN EN ISO 4589-2.

UL94-V test: Performed in accordance with DIN EN 60695-11-10.

| | #1 | #2 | #3 | #4 |
|---|---|---|---|---|
| Zetpol 2010L | 80 | 80 | 95.50 | 95.50 |
| ZSC 2195LCX | 20 | 20 | | |
| APYRAL 60CD | 140 | 180 | 180.00 | 180.00 |
| Saret 633 (ZDA) | | | 4.50 | |
| Saret 634 (ZDMA) | | | | 4.50 |
| Phosflex 362 | 5.00 | 5.00 | 5.00 | 5.00 |
| Zinc Oxide XFT-H | 3.00 | 3.00 | 3.00 | 3.00 |
| Ultralube IMX | 2.00 | 2.00 | 2.00 | 2.00 |
| Vanox CDPA | 1.50 | 1.50 | 1.50 | 1.50 |
| Vanox ZMTI | 1.00 | 1.00 | 1.00 | 1.00 |
| TAIC | 1.00 | 1.00 | 1.00 | 1.00 |
| SR-517 | 4.00 | 4.00 | 4.00 | 4.00 |
| Luperox F40P-SP2 | 8.00 | 8.00 | 8.00 | 8.00 |
| TOTAL phr | 265.50 | 305.50 | 305.50 | 305.50 |
| Mooney viscosity | 68.6 | 81.9 | 88.8 | 79.0 |
| ML1 + 4/100° C. (MU) | | | | |

Mooney scorch ML1 + 30/125° C.

| | | | | |
|---|---|---|---|---|
| Minimum viscosity (MU) | 38.1 | 50.0 | 57.6 | 49.7 |

MDR, 170° C./30 min, 100 cpm, 0.5° arc

| | | | | |
|---|---|---|---|---|
| ML, (dN · m) | 0.8 | 1.0 | 1.4 | 1.1 |
| MH, (dN · m) | 35.0 | 47.2 | 46.8 | 39.4 |
| Ts2, (min) | 1.3 | 1.2 | 1.1 | 1.3 |
| T′90, (min) | 11.8 | 11.6 | 9.5 | 11.1 |
| T′90 tan delta (—) | 0.155 | 0.153 | 0.133 | 0.149 |
| Shore A hardness (pts) | 90 | 93 | 91 | 90 |

Tensile properties (ISO-37, type 2, 500 mm/min)

| | | | | |
|---|---|---|---|---|
| Modulus @ 10% (MPa) | 2.3 | 3.44 | 2.59 | 2.51 |
| Modulus @ 25% (MPa) | 3.78 | 5.88 | 4.88 | 4.17 |
| Modulus @ 50% (MPa) | 5.8 | 8.25 | 8.2 | 6.39 |
| Modulus @ 100% (MPa) | 9.2 | 11.8 | 12.5 | 9.15 |
| Tensile strength (MPa) | 14.9 | 15 | 17.6 | 10.9 |
| Elongation at break (%) | 271 | 222 | 180 | 294 |

Tear resistance (DIN ISO 34, trouser)

| | | | | |
|---|---|---|---|---|
| Tear strength (N/mm) | 7.4 | 6.7 | 4.6 | 9.7 |
| Limited Oxygen Index (% O2) | 33.3 | 36.1 | 35.4 | 33.6 |
| (DIN EN ISO 4589-2) | | | | |
| UL94V classification | V0 | V0 | V0 | V0 |
| (DIN EN 60695-11-10) | | | | |

### Examples Part 2

Curing conditions: 170° C./20 min press-cure, 150° C./4 h post-cure

LOI test: Test sheet thickness of 3 mm

UL94V test: Test sheet thickness of 2 mm, flame with 50 W power, 450 burning angle.

| | #5 | #6 | #7 |
|---|---|---|---|
| Zetpol 2010L | 100 | 100 | 100 |
| APYRAL 60CD | 180 | 180 | 180 |
| TOTM | 5.00 | | 5.00 |
| Phosflex 362 | | 5.00 | |
| Zinc Oxide XFT-H | 3.00 | 3.00 | 3.00 |
| Ultralube IMX | 2.00 | 2.00 | 2.00 |
| Vanox CDPA | 1.50 | 1.50 | 1.50 |
| Vanox ZMTI | 1.00 | 1.00 | 1.00 |
| TAIC | 1.00 | 1.00 | 1.00 |
| SR-517 | 4.00 | 4.00 | 4.00 |
| Luperox F40P-SP2 | 8.00 | 8.00 | 8.00 |
| TOTAL phr | 305.50 | 305.50 | 305.50 |
| Mooney viscosity | 93.3 | 102.4 | 119.3 |
| ML1 + 4/100° C. (MU) | | | |

Mooney scorch ML1 + 30/125° C.

| | | | |
|---|---|---|---|
| Minimum viscosity (MU) | 58.4 | 61.0 | 76.6 |

MDR, 170° C./30 min, 100 cpm, 0.5° arc

| | | | |
|---|---|---|---|
| ML, (dN · m) | 1.36 | 1.58 | 1.92 |
| MH, (dN · m) | 31.5 | 28.5 | 33.6 |
| Ts2, (min) | 1.6 | 1.7 | 1.6 |
| T′90, (min) | 14.0 | 13.8 | 13.4 |
| T′90 tan delta (—) | 0.157 | 0.177 | 0.166 |
| Shore A hardness (pts) | 81 | 78 | 82 |

Tensile properties (ISO-37, type 2, 500 mm/min)

| | | | |
|---|---|---|---|
| Modulus @ 10% (MPa) | 1.39 | 1.31 | 1.46 |
| Modulus @ 25% (MPa) | 2.33 | 2.00 | 2.31 |
| Modulus @ 50% (MPa) | 3.12 | 2.45 | 2.99 |
| Modulus @ 100% (MPa) | 4.30 | 2.83 | 3.61 |
| Tensile strength (MPa) | 7.5 | 8.0 | 7.3 |
| Elongation at break (%) | 575 | 576 | 533 |

Tear resistance (DIN ISO 34-1, trouser)

| | | | |
|---|---|---|---|
| Tear strength (N/mm) | 15.1 | 15.9 | 10.0 |
| Limited Oxygen Index (% O2) | 35.6 | 42.5 | 43.9 |
| UL94V classification | V0 | V0 | V0 |

Test for Limiting Oxygen Index (LOI)

LOI is an indicative value for the assessment of flame retardancy. It describes the minimum concentration of oxygen in an oxygen/nitrogen mixture which is sufficient to support combustion of a vertically oriented specimen.

Determination via device Stanton Redcroft FTA Flammability Unit. The testing is done according to DIN EN ISO 4589-2.

Dimensions of used specimen—punched via pneumatic punching machine:

Length=80 mm

Width=7 mm

Thickness=3+/−0.25 mm

4 specimens are tested

The specimens are preconditioning at: 23° C., 50% RH, for 48 h.

Ignition source: propane torch with flame of 16 mm+/−4 mm; flame exposure period: 5 s.

Procedure: Specimen is vertically fixed in the device. A defined oxygen atmosphere is adjusted. Specimen is exposed to flame on the upper end for 5 sec. The concentration of oxygen which is necessary to support combustion of the specimen is determined. The higher the LOI, the better is flame retardancy of the compound.

### UL94-V Test

The testing done according to DIN EN 60695-11-10, using a UL94 box of Taurus Instruments.

Dimensions of used specimen—punched via pneumatic punching machine:

Length=125+/−5 mm

Width=13.0+/−0.5 mm

Thickness=2+/−0.25 mm (typically 0.8/1.6/3.2 mm)

5 specimens are tested

The specimens are preconditioning at 23° C., 50%+/−10% RH, for 48 hrs.

Ignition Source: Bunsen burner, 50 W, gradient of 45°. Height of flame: 20+/−2 mm.

Procedure: A total of 5 specimens are tested per thickness. Specimen is mounted vertically so that its lower end is 10 mm above Bunsen Burner Tube and 300 mm+/−10 mm above a layer of dry absorbent cotton.

Flame is applied to the center of the lower edge of the specimen for 10 seconds and removed. If burning ceases within 30 seconds, the flame is reapplied for an additional 10 seconds.

Requirements for V-0
The specimens may not burn with flaming combustion for more than 10 seconds after either application of the test flame.
The total flaming combustion time may not exceed 50 seconds for each set of 5 specimens.
The specimens may not burn with flaming or glowing combustion up to the holding clamp.
The specimens may not drip flaming particles that ignite the cotton located 300 mm below the test specimen.
The specimens may not have glowing combustion that persists for more than 30 seconds after the second removal of the test flame.

### Requirements for V-1

The specimens may not burn with flaming combustion for more than 30 seconds after either application of the test flame.
The total flaming combustion time may not exceed 250 seconds for each set of 5 specimens.
The specimens may not burn with flaming or glowing combustion up to the holding clamp.
The specimens may not drip flaming particles that ignite the cotton located 300 mm below the test specimen.
The specimens may not have glowing combustion that persists for more than 60 seconds after the second removal of the test flame.

Requirements for V-2
The specimens may not burn with flaming combustion for more than 30 seconds after either application of the test flame.
The total flaming combustion time may not exceed 250 seconds for each set of 5 specimens.
The specimens may not burn with flaming or glowing combustion up to the holding clamp.
The specimens can drip flaming particles that ignite the cotton located 300 mm below the test specimen.
The specimens may not have glowing combustion that persists for more than 60 seconds after the second removal of the test flame.

### Cone Calorimetry

Cone calorimetry testing is done according to ISO 5660-1 using a FTT Dual Analysis Cone Calorimeter.

Dimensions of Used Specimen:

Length=100 mm

Width=100 mm

Thickness<50 mm

3 specimens are tested. The specimens are preconditioned at 23° C., 50% RH, for 24 hrs.

Procedure: A horizontal specimen is mounted under a steel frame so that only the surface and no edges are exposed to a conical radiator pre-set to a radiant heat of 25 or 50 W/m2. A spark ignition is used and the specimen is mounted on a load cell. Combustion is observed and the measurement applied for 1200 sec.

Parameter measured in the cone calorimeter are:

Time to Ignition (TTI)

Mass Loss

Heat Release Rate (HRR)

Total Heat Release (THR)

Peak of Heat Release Rate (PHRR)

AHRE (Average Rate of Heat Emission)

MAHRE (Maximum of AHRE)

Smoke production

CO/CO2 ratio

### Electrical Volume Resistivity Testing

Electrical Volume Resistivity is done according to DIN IEC 60093 using a HM 307 DE device and measuring electrode.

Dimensions of Used Specimen:

Length: 100 mm

Width: 100 mm

Thickness: <50 mm

4 specimens are tested. The specimens are preconditioned by cleaning their surface with ethanol and storage over night at 23° C. and 50% RH. The measuring voltage is 100 V for a period of 1 minute.

What is claimed is:

1. A rubber blend comprising hydrogenated nitrile rubber, zinc acrylate, and alumina trihydrate.

2. The rubber blend of claim 1, wherein the zinc acrylate is selected from zinc methacrylate, zinc di-methacrylate, or both.

3. The rubber blend of claim 1, further comprising a plasticizer.

4. The rubber blend of claim 1, wherein part of the hydrogenated nitrile rubber and the zinc acrylate are a nanocomposite.

5. The rubber blend of claim 4, wherein the blend comprises
about 60 phr to about 100 phr hydrogenated nitrile butadiene rubber,
about 10 phr to about 40 phr hydrogenated nitrile butadiene rubber and zinc acrylate nanocomposite, and
about 100 phr to about 200 phr alumina trihydrate.

6. The rubber blend of claim 1, wherein the alumina trihydrate has a D90 particle size ranging from 0.6 μm to 3.2 μm.

7. The rubber blend of claim 1, wherein the curing system comprises a peroxide.

8. The rubber blend of claim 1, further comprising zinc oxide.
